(19) United States
(12) Patent Application Publication
(10) Pub. No.: US 2004/0009764 A1
(43) Pub. Date: Jan. 15, 2004

(54) Telecommunication-based common contracting

(76) Inventor: James G Hazard, Paris (FR)

Correspondence Address: PERKINS, SMITH & COHEN LLP, ONE BEACON STREET, 30TH FLOOR, BOSTON, MA, 02108, US

(21) Appl. No.: 10/344,603

(22) PCT Filed: Jul. 26, 2001
(86) PCT No.: PCT/US01/23573

(30) Foreign Application Priority Data
Jul. 28, 2000 (US) 60221400

(51) Int. Cl. H04M 3/00; H04Q 7/20

(52) U.S. Cl. 455/418; 455/419; 455/445

(57) ABSTRACT

Agreement formation system utilizing a global telecommunications network (14) with independently stored contract terms and/or supplements to contract term accessible by contracting or potentially contracting parties (12), and optimally others, over the network through addressing modularity stored terms and supplements to enable establishment of party accord, and verification of content of addressed modules and also enabling a community colloquy to advance modules contents.

### FIELD OF THE INVENTION

The present invention relates to information storage and telecommunications systems and more particularly to such systems merged for facilitating contracting.

### BACKGROUND OF THE INVENTION

The classic method for parties to form an important contract is by agreeing on a text that states the terms (provisions) of their agreement and signing and exchanging multiple originals of the text in paper form. There are numerous variants of this, such as a written offer accepted by performance, an oral contract and a contract signed electronically, but for purposes of the present inventions, the essence is that a text is adopted as the parties' agreement.

The range of issues that the parties may agree on is very broad. In addition to the essential business terms defining the transaction, the parties may also specify numerous accessory terms dealing with contingent issues such as breach, peripheral issues such as the method of delivery, and background issues such as that a seller of a product is its rightful owner. Even with respect to issues for which the law provides a rule, the parties are often free to agree to a different rule.

The law gives great weight to the choices made by the parties. In any subsequent controversy, a provision of the agreement will usually be enforced in accordance with its terms even if it is unusual or apparently unjustified. This is the principle of party autonomy.

The law ordinarily treats the signed text as definitive proof of the parties' agreement. It does not ordinarily matter that a party did not read the text or understood it in a particular sense or that the parties had a previous inconsistent understanding or agreement.

Writing an agreement that is complete, clear and commercially reasonable is difficult even for a specialist. It requires skill in the use of contract language, extensive knowledge of the issues and applicable law, and the time and resources to work through all issues. Specialist assistance is available, but at a high cost. The cost is more burdensome for a party that has less experience in a type of transaction since it ordinarily needs more assistance and has less opportunity to amortize the cost over a number of transactions.

Reviewing an agreement is nearly as difficult as writing one. It, too, requires sensitivity to the use of contract language, extensive knowledge of the issues and applicable law, and the time and resources to read the entire text and work through the issues. A reviewer may be the counter-party in the transaction or a collaborator, advisor or other business relation of either party. A single agreement may be reviewed by many different persons and may be reviewed in many versions during the course of a transaction. A counter-party of the proposing party and its collaborators and advisors must also be especially alert for omitted issues, provisions that disfavor it expressly or by subtleties of drafting and changes between versions of a document.

Conventional methods also impose a severe trade off between the scope and detail of treatment of the issues, on the one hand, and the ease of presentation and review, on the other hand. Greater length of the text increases the burden of production and especially of review, and may make presentation cumbersome. Accordingly, the range of the issues addressed and the manner of addressing them is severely limited.

Conventional methods result in a great diversity of expression for contract terms that serve the same function. This limits the development of knowledge about the meaning of any particular expression and the opportunities for prospective parties to share information with other similarly situated past or prospective parties and to coordinate negotiation positions among themselves.

Certain methods and systems currently exist to facilitate preparing the text of a contract agreement and in some limited circumstances they may facilitate reviewing it and sharing of knowledge.

Collections of precedent agreements provide examples of terms used for previous transactions taking place in more or less similar circumstances. Most businesses and lawyers have such collections, and there are numerous independent sources for them. Precedents facilitate preparing an agreement when the circumstances of the transaction are closely similar to the one from which the precedent comes.

Forms extend precedents because they are specifically written for re-use and do not contain provisions relating to the unique aspects of a particular transaction. Form agreements may contain alternative terms designed to fit a number of different circumstances.

Document assembly systems extend forms by providing a method of selecting among the alternatives, sometimes with the aid of an expert system. Document assembly systems may also aid the preparation of the text by permitting the user to input information once, storing it and inserting it wherever appropriate in resulting documents.

Trade associations may recommend a particular form of agreement and in some cases this form is available on pre-printed on paper pages that are marked to assure that they are originals. A trade association agreement may become a market standard.

These methods have significant limitations. Except with recommended forms preprinted on marked paper, the preparing party must check for inadvertent inconsistencies with the form, and the reviewing party must check for both inadvertent and intentional inconsistencies. A document assembly system will ordinarily reduce the likelihood of errors, but the resulting document still must be checked. A recommended form pre-printed on marked paper is available only in limited circumstances and is difficult to manipulate, especially with word processing systems, because information must be completed in particular places on the pre-printed page of paper.

There are a large number of different precedents and forms. Except where the parties have previously done a similar transaction with one another or the market has established a particular form, the reviewing party will probably be unaware of the form preferred by the proposing party. An agreement derived from an unfamiliar form does not reduce the burden of review.

It is a principal object of the invention to facilitate contract negotiations by overcoming the need to check and review standard provisions, to increase the likelihood that a party will be familiar with a term and to increase the number issues that can be treated and the detail in which they are treated.

### SUMMARY OF THE INVENTION

Much of the inefficiency in contract negotiation lies in the review process, not in writing the agreement. Tools that aid drafting do not directly tackle this problem. The present invention provides an incorporation by reference approach preferably through online referencing. Online referencing speeds review because the unchanging parts of agreements are on a trusted internet site. Parties refer to these texts instead of copying them into the agreement. The reference is known legally as incorporation by reference and is recognized in most legal systems. There is nothing inherently technical about this notion and the reference can be a simple statement on a paper document. By exporting the standard language to a web site, the signed document is reduced to the unique aspects of the transaction. Ideally, it can be a term sheet and a list of negotiated changes to the online texts. A party must, of course, review the text the first time, but not thereafter.

In the simplest structure, online referencing requires only a signed document containing the deal points and any modifications, and a stock contract hosted on a trusted website. This simple structure is preferable for some settings, but for more fluid or complex situations a layered agreement is more efficient.

It is preferred to place terms and/or supplements (including organizational features) in modules with location addresses such as uniform resource locators (URLs) ad to incorporate them into agreements and agreement proposals by URL reference. The modules are maintained in web sites by an agreement party or a neutral, preferably the latter.

Where a neutral maintains terms and/or supplements and is publicly accessible to some degree (or in a closed society such as a trade or professional association), many interested persons can upload proposed terms and/or supplements and/or variation of or comments on either to elicit responses and the terms and/or supplements can be improved in any such colloquial procedures.

By using incorporation by reference among a group of contract agreements and components on a site, it is possible to make them much more powerful and extensible. Each principle or element can be stated once in a complete form and re-used by reference wherever needed, a structure called herein “layering.” Users must learn to read while following a series of links, but with a bit of practice this comes to feel natural and efficient.

The terms are in modules addressable singly or as groups. Modules can also be provided for a number of supplementary features including organizational features as well as issues, circumstances, and other modular supplements described below.

In a formally-structured system, a library of standard definitions and clauses serve as the foundation for full agreements. This bottom-to-top approach provides internally consistency, automatic updating and rapid drafting once the base is laid. A fully layered system has some similarities to the components of a document assembly system. Layering can also occur less formally. Users who frequently put certain modifications or additional provisions into their signed agreements can package those modifications as a template and post it on a web site or the like. Templates also provide a good method for keeping track of changes frequently made to a stock agreement.

Online contracting becomes “open contracting” when the terms are hosted on a neutral site and are open to a community of users who have the right to comment on the terms. This form of sharing permits individual parties to benefit from the scrutiny, experience and judgment of the community of users and experts.

Terms may also be sponsored by an organization, bar group or publisher. For instance, a consumer organization can suggest to its members that they use particular terms for their online hotel and plane reservations. A trade group can suggest the use of a particular form for sales between group members and their suppliers. Terms can be given common sense names that can be recognizable on web pages or on paper. This open contracting permits new information flows that improve contracting.

Open contracting pursuant to the invention is about transparency, not a particular outcome. Contract terms cannot be generic—they must take specific positions on substantive issues and require particular ways of doing things. Any given solution may be inappropriate in the particular circumstances, unenforceable in a particular jurisdiction or unacceptable to a particular party.

There are at least four ways to disagree with a substantive point in an online document.

Parties to a transaction can write a more appropriate term into their agreement or other accord. A party who feels strongly about the point in principle can also post on the site a recommendation that other users do the same, and even provide a recommended test.

A user who expects to frequently use an alternative term can post it on the site as a “template.” A template states one or more modifications and incorporates by reference an existing document. A template has the advantage that it can be directly referred to instead of the underlying document.

A more complete, or aggressive, approach is to write an alternative document and post it on the site. An alternative document is more readable if there are many changes, and can be a political statement. It has the disadvantage of causing a fork in the terms; thereafter, improvements, comments and annotations need to be made or cross-referenced in two places instead of one. This is not fatal, and if the new document is widely thought to be better than the old one, the new may eclipse the old.

A final alternative is to advocate changing the offending point in a subsequent version of the document. This can be done quite freely if the document has not yet been used. Once a document has developed a following, however, new versions should generally only make corrections and improvements. A reversal of position in a new version of an existing document could easily wrong-foot users who are familiar with it.

Subject to the foregoing overview, the objects of the invention are met through three related methods.

The first is a method for adopting a text as part of the definitive statement of the agreement between parties to a contract comprising the steps of: establishing a global network site under the control of a person independent of any potential user; placing on the site a multiplicity of contract provisions; and making such terms available for review by a multiplicity of potential users and others; and agreeing by any legal means a contract between users that includes by reference some or all of such provisions.

The foregoing method may be improved by: writing the term in a manner that eases incorporation by reference;

Saving a permanent record of such provisions; certifying the text of the terms; organizing some such terms into modules each treating an issue in a manner suitable for a variety of contracts; organizing some other such terms into modules each of which treats a multiplicity of issues commonly involved in a particular type of business operation or transaction and refers to at least one issue module for its terms; labeling each such term with a unique identifier; labeling each such term with a unique identifier that corresponds to the issues addressed in the text of such term; providing at least one such term that characterizes the legal effect of a reference to some such provisions; providing a means for notification to users of a change in any such term; and providing a means for users to comment on the term and for other users to access such comments.

The preceding agreement simplifying system permits the author of a contract text to refer to terms that are hosted on the global network site instead of repeating them in the text of the agreement. The author of the agreement thus reduces the burden of including and checking the text. The reviewer of the agreement need review the provisions only when using them for the first time, and thereafter only needs to check that the reference is accurate.

Since such terms are separated from the agreement text and refused, they can be developed in greater detail than in a conventional contract.

An independent party controlling the terms and maintaining a permanent copy of such terms increases assurance that the users can rely on such terms being maintained and a permanent record being kept.

The second system is a method to permit improvements to the standard contract terms on a global network site without interfering with the function of previous references to those terms and without requiring a party to review the standard terms for changes since the previous time they used the terms. The global network site maintains a permanent record of all versions of the terms, together with a record of the date on which such provisions became effective and when (if applicable) they were superceded. The global network site provides a listing of the changes and corresponding dates, and a means for viewing the terms as they existed at any particular previous time. The global network site incorporates provisions that specify that a reference to the provisions will be deemed to mean the provisions as they existed at a date of reference determined based on criteria such as the date the agreement was first signed by one of the parties or the date the text of the agreement was finalized. The parties may also select a particular date of reference in their agreement. The global network site provides notification to subscribers of modifications to terms.

The following describe systems and methods facilitating the familiarity of potential parties with the standard terms and their extension into a variety of different types of transactions.

The standard terms are organized into modules of two general categories. The first category of modules is “issue” modules that address a particular contract function, such as notices, or particular legal issue, such as invalidity. Issue modules express general rules in a manner such that they can be applied to a broad range of contracts. They may contain exceptions and alternatives applicable to particular circumstances, each of which is identified with a label to facilitate inclusion or exclusion of them in a contractual reference.

The second category of modules is “form agreement” modules, which contain a modest amount of original text, and simulate the terms of a full contract agreement through references to issue modules. The division of functions between issue modules and agreement modules permits the rapid development of new agreements while focusing feedback on the same blocks of text in the issue modules.

A third category of modules can be envisioned that relate to particular circumstances, such as the law applicable to the agreement, government procurement rules or the language of the contract. These would specify modifications to the provisions of the issue modules applicable under specified circumstances. By treating these issues in isolation, feedback relating to the specified circumstances is focused on the circumstance modules rather than being diffused in the issue modules.

The system provides a means to enable an election of the parties such that subsequent modifications may be notified to them by the network site and they may be deemed to accept each such modification unless they reject it in a timely manner by notice to the other party. The site may also provide a method for presenting the provisions as they existed at any prior time, and certificates can be made available relating to any prior time. This permits parties to existing contracts to benefit from improvements in the system and may provide feedback from them regarding the effect of a proposed change on their contract.

The global network site maintains a system for electronic discussion groups and workgroups to facilitate communication among current and prospective users and commentators regarding the standard provisions and their use. The discussion and workgroup systems permit participants to propose modules, alternative versions and additional provisions.

One method (among others enabled by these systems) comprise collaborative development by the formation of a committee of experts with connections to particular constituent groups affected by the matter under discussion and by neutral experts, where the neutral experts may moderate the discussion, and propose texts and a particular text can be published with the recommendation.

Another method of such collaborative development allows qualified participants to recommend a particular provision, with a method of presenting the provisions recommended by a participant and the participants recommending a provision.

Other objects, features and advantages will be apparent from the following detailed description of preferred embodiments taken in conjunction with the accompanying drawings in which:

### BRIEF DESCRIPTION OF THE DRAWING

FIGS. 1-6 are block diagrams of the three basic systems described above according to a preferred embodiment of the invention; and

FIGS. 1A, 1B . . . , 2a, 2B . . . , 3A, 3B . . . are block diagrams of detailed implementation of FIGS. 1-3 (and alternatives)

### DETAILED DESCRIPTION OF PREFERRED EMBODIMENTS

Referring now to the drawing figures it is seen that the systems comprise the following:

FIG. 1, a computer workstation (2), a global network (4), a global network site (6), a page on the global network site (8), a contract provision (10) and a unique identifier for such contract provision (12). Such station and such site are connected to such network. Such page is stored on such site. Such contract provision is on such page. Two users wishing to enter into a contract use at least one such station to read the text of such provision and incorporate such provision into their contract using any legally valid means.

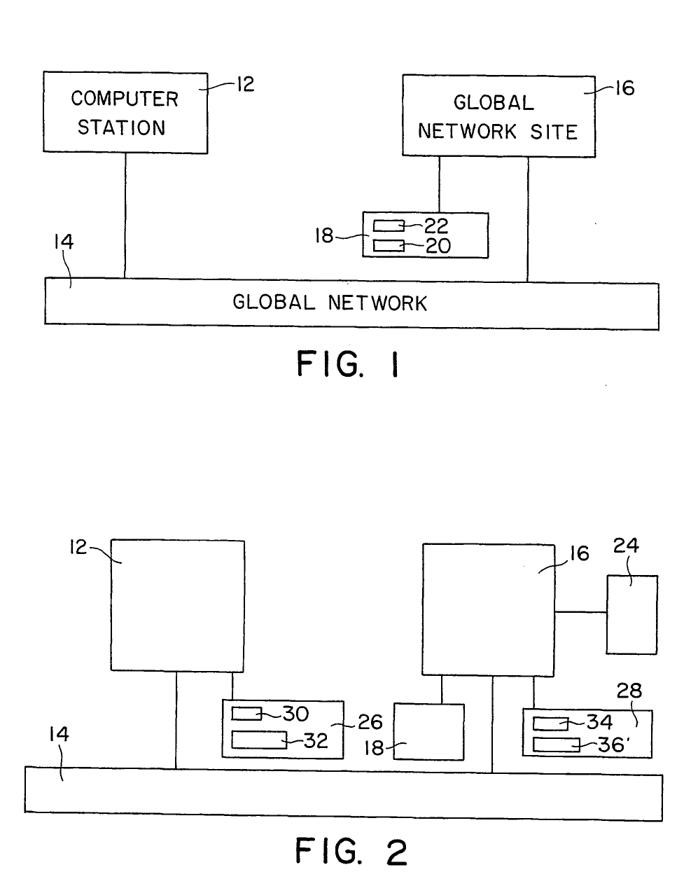

FIG. 2 shows a system for notifying the user of changes to such provision, consisting of such station, such network, such site, such page, a computer program (14), a request (16) and a notification (18). A user desiring to be informed of a change in such page submits such request to such program by electronic message specifying such page (20) and such user's address on such network (22). Such program registers such request. Such program regularly checks such page for modification and in the event a modification is detected it generates such notice and sends it by electronic mail addressed (24) to such user's address on such network and the identity of the page that was modified (26). Such program may be integrated with the site management so that a modification to such page automatically starts the generation of such notice.

FIG. 3 shows a system for agreeing on the text of a contract terms comprising at least three such stations (2, 28 and 30), such network, such site, such page, such contract provision, at least two electronic messages (32 and 34) and a program (36). Two or more users who are potential parties to contracts relating to specified types of transactions and at least one user who is not a potential party to any such contract each use at least one such station to conduct an exchange of electronic messages in which some such potential party users identify their requirements for the text of one or more such provisions to be used in a contract. Such non-party user reviews the requirements specified by such party users in their messages, writes at least one such provision that it believes is suitable for use by the parties and places it on at least one such page on such site. The exchange of such messages and such writing of provisions continues until the non-party user decides to end the exchange.

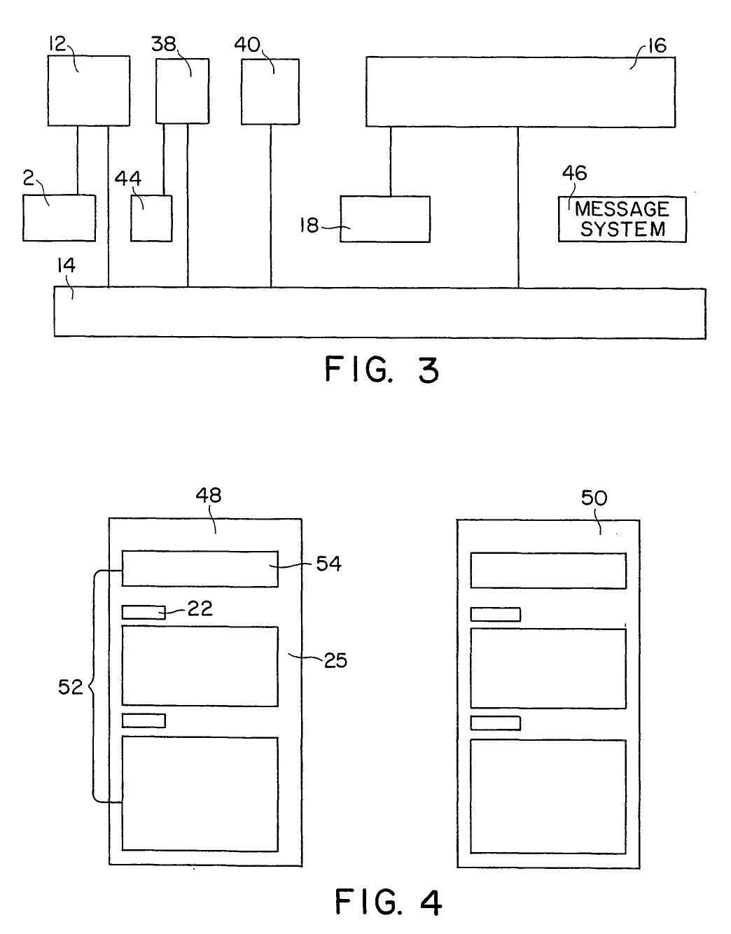

FIG. 4 shows a preferred method for organizing such provisions on such site, comprised of a multiplicity of pages (38 and 40) where each page contains a module of text (42) consisting of a heading (44) and one or more such provisions (14) and unique identifier (12) relating to one element selected from the class consisting of issues commonly treated in contract agreements and types of contract agreements. Each such module treating an issue contains one or more such provisions treating an issue in a manner that is sufficiently general and detailed to make such module suitable for use in a variety of contract situations. Each such module treating a contract type simulates the majority or a part of the text of a type of contract agreement by providing a framework for a contract agreement and including some such issue modules by reference in that framework, and, optionally, one or more additional provisions relating to other matters or overriding one or more terms of an issue module. Such organization facilitates re-use of such issue provisions, thereby facilitating review by a user familiar with one or more such provisions from an earlier use, balance and completeness, and the accumulation of experience. It also facilitates creation of new structure modules.

### EXAMPLES

The following non-limiting illustrative examples show how the systems described above may be employed to sample problems of contract negotiation and drafting.

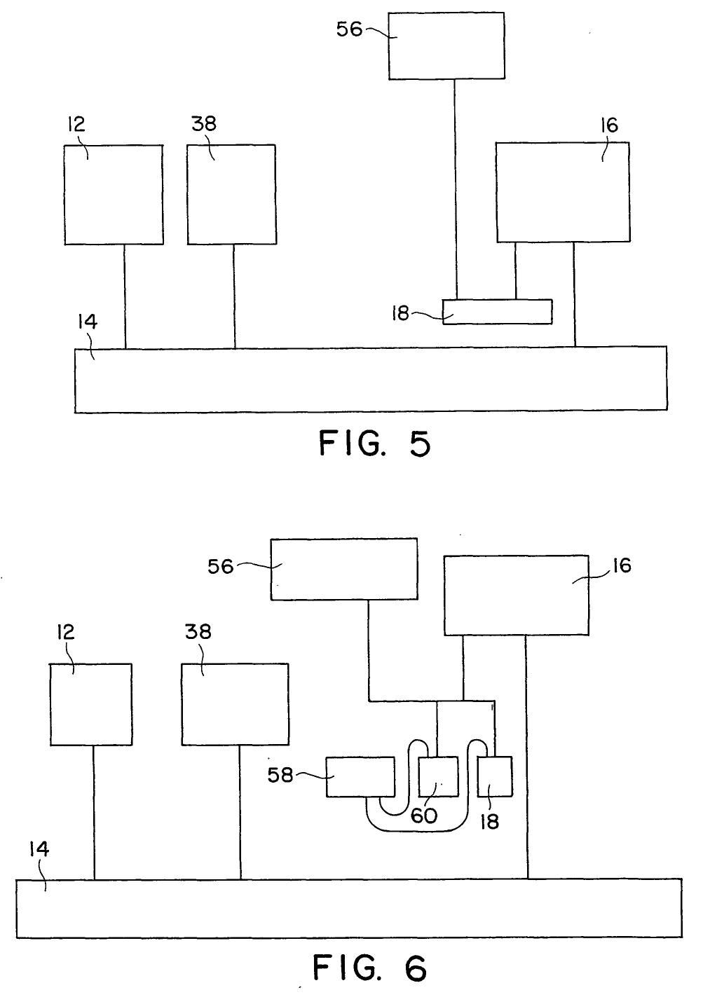

In a first example relating to a user that is a company wishing to disclose confidential business with a prospective investor, FIG. 5 shows one such station that the company uses to view one such page on such site, an agreement (46) that the company writes specifying the other terms of the contract and incorporating such provision by reference. The company signs and sends two originals of such agreement to a second user that is a prospective investor in the first user. The second user reads such originals and uses a second such station to review such provision, signs both such originals and returns one original to the first user. In this example, the users have made a contract including such term. Neither user copied or checked such provision for errors of manipulation and if either party is already familiar with such provision, it did not need to review it. Where such site is maintained under the control of a user independent of parties to the contract, one or both users may also be comforted by the reputation of such site or such independent user.

FIG. 6 shows a variation of the example above, in which such first user accesses a plurality of pages on such site, views one such module (48) regarding a contract type on one such page that references two issue modules (8 and 50), views such issue modules on other such pages, writes an agreement including the structural module, signs and sends two originals of such agreement to such second user. Such second user reads such originals and uses such second station to review all three such modules, signs both such originals and returns one original to the first user. In this example, the users have made a contract including all such modules.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1- Agreement formation system comprising, in combination:
(a) means for maintaining common agreement terms as modules under control of a party independent of contracting or potentially contracting parties and an inventory of terms modules so maintained with variation of particular terms modules as earlier and later versions and/or temporally overlapping alternatives;
(b) means for effecting access to the inventory by potentially contracting and contracting parties via a telecommunication network;
(c) means for establishing accord of the parties to specific versions of one or more of the inventoried terms of particular modules, by an addressing type of reference thereto,
(d) means for verifying via a telecommunications network the accord of parties to one or more particular terms/variants, including verification of terms being as represented.

2- The system of claim 1 and further comprising
(e) means for access to the maintaining party by the potentially contracting or contracting parties for services selected from the group of verifying particular terms and variations thereof.

3- The system of claim 2 and further comprising
(d) means for verifying the accord of parties to one or more particular terms/variants.

4- The system of claim 2 and further comprising
(f) means for maintaining a revision history data base accessible to potentially contracting and contracting parties.

5- The system of claim 4 and further comprising
(g) means for automatic notification from the database to subscribers of all or pre-selected portions of its contents.

6- The system of claim 1 further comprising
(h) means for maintaining one or modules of one or more supplements to terms, the supplement(s) being selected from the group consisting of issues modules, transaction modules, circumstance modules, definitions of terms modules and transposition modules.

7- The system of claim 6 and further comprising
(i) means for access to the maintaining party by the potentially contracting or contracting parties for services selected from the group of verifying particular module contents.

8- The system of claim 7 and further comprising
means for verifying the accord of parties to one or more particular terms/variants and related supplemental modules contents.

9- The system of claim 7 and further comprising
(k) means for maintaining a revision history data base accessible to potentially contracting and contracting parties for substantially all modules.

10- The system of claim 9 and further comprising
(l) means for automatic notification from the database to all or selected portions of database subscribers of all or pre-selected portions of its contents, with means for selective adoption of the broadcast materials by one or more subscribers.

11- The system of claim 6 and further comprising
(m) means for contracting parties to add to the modules contents terms applicable to them in future contracting activities.

12- The system of claim 6 and further comprising
(n) means for parties who are not contracting with each other to legislate modular contents additions and revisions available to future parties for review and/or agreement to be bound thereby.

13- The system of claim 6 and further comprising
(o) means for unilateral pre-acceptance of contents of one or more modules with or without conditions of such pre-acceptance.

14- The system of claim 6 and further comprising
(p) means for orderly annotation of contents of one or more modules.

15- The system of claim 13 wherein on or more of such annotations affects meaning of an agreement term.

16- The system of claim 6 and further comprising
(m) means for contracting parties to add to the modules contents terms applicable to them in future contracting activities;
(n) means for parties who are not contracting with each other to legislate modular contents additions and revisions available to future parties for review and/or agreement to be bound thereby;
(o) means for unilateral pre-acceptance of contents of one or more modules with or without conditions of such pre-acceptance; and
(p) means for orderly annotation of contents of one or more modules.

17- The system of claim 6 and further comprising
(q) means for unilateral pre-acceptance of contents of one or more modules with or without conditions of such pre-acceptance.
